(19) United States
(12) Patent Application Publication
(10) Pub. No.: US 2007/0052833 A1
(43) Pub. Date: Mar. 8, 2007

(54) Variable magnification optical system and image-taking apparatus

(75) Inventors: Kazuaki Matsui, Osaka-shi (JP); Naoki Hashimoto, Toyokawa-shi (JP); Hiroshi Mashima, Sakai-shi (JP); Hideo Onishi, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/344,722

(22) Filed: Feb. 1, 2006

(30) Foreign Application Priority Data
Sep. 2, 2005 (JP) 2005-254372

(51) Int. Cl. H04N 5/225; G02B 13/16

(52) U.S. Cl. 348/335

(57) ABSTRACT

A variable magnification optical system includes: a plurality of lens groups for imaging a ray from the object side onto the light-receiving surface of an image sensor; and an optical prism for deflecting the optical path of the ray guided by these lens groups. The variable magnification optical system further includes an anamorphic lens element, which alters a beam of rays so that the beam becomes nonaxisymmetric to the optical axis.

This application is based on Japanese Patent Application No. 2005-254372 filed on Sep. 2, 2005, the contents of which are hereby incorporated by reference.

### BACKGROUND OF THE INVENTION

1. Field of the Invention

The present invention relates to a variable magnification optical system and an image-taking apparatus such as a digital still camera or the like.

2. Description of Related Art

Following the wide spread use of personal computers (PC), digital still cameras (DSC) that can easily take in images have been wide spread in recent years. Thus, as is the case with cameras employing a sliver-film (silver salt cameras), there has been a demand for such digital cameras to be more multifunctional and downsized (slimmed-down).

Examples of multifunctional apparatuses include a DSC (image-taking apparatus) that can photograph panorama images. For example, patent publication 1 to be described below discloses a DSC that is capable of obtaining from a subject a ray with a relatively large angle of view through a cylindrical lens to thereby photograph a panorama image. It is especially appreciated that, with the DSC disclosed in this patent publication 1, the cylindrical lens can be installed in and removed from the optical path to thereby easily obtain images taken with different angles of view.

| | |
|---|---|
| [Patent publication 1] | Japanese Patent Application No. 2005-62531 |
| | (laid open on Mar. 10, 2005) |

However, in the DSC disclosed in patent publication 1, the use of the cylindrical lens is only intended for obtaining a panorama image and thus not for downsizing the apparatus.

### SUMMARY OF THE INVENTION

In view of the problem described above, the present invention has been made, and it is an object of the invention to provide a variable magnification optical system or the like that is easily downsized (slimmed-down) through the use of at least one optical element.

To achieve the object described above, one aspect of the present invention refers to a variable magnification optical system including: a plurality of lens groups for imaging a ray from the object side onto the light-receiving surface of an image sensor; and an optical axis altering element for deflecting the optical axis of the ray guided by the plurality of lens groups. The variable magnification optical system further includes a first-type optical element, which alters a beam so that the beam becomes nonaxisymmetric to the optical axis.

This alteration occurs since the first-type optical element has refractive powers respectively corresponding to a plurality of different directions orthogonal to the optical axis. For example, where, of the different directions orthogonal to the optical axis, the mutually orthogonal directions are represented as a first direction and a second direction, the first-type optical element has the refractive power corresponding to the second direction thereof which is larger than the refractive power corresponding to the first direction thereof.

With such a configuration, the width of a beam corresponding to one of the directions orthogonal to the optical axis (for example, second direction) is relatively shortened by the first-type optical element. Therefore, the plurality of lens groups are only required to have a diameter (size) that permits condensation of the beam shortened (compressed). Thus, the variable magnification optical system having the first-type optical element can have smaller diameters of the lens groups than variable magnification optical systems having no first-type optical element (due to the downsizing effect provided by the first-type optical element).

In the variable magnification optical system of the invention, downsizing is also achieved by deflecting (right-angle defection or the like) the optical axis by the optical axis altering element (thus providing downsizing effect by the optical axis altering element). For example, where the optical axis direction of a ray incident on the optical axis altering element is represented as an incidence direction while the optical axis direction of a ray deflected by the optical axis altering element is an emergence direction, the optical axis altering element deflects the optical axis so that the angle formed by the incidence direction and the emergence direction becomes substantially 90 degrees. In this case, the length of the variable magnification optical system is shortened along the incidence direction.

Consequently, as is the case with the invention, the variable magnification optical system including the first-type optical element and the optical axis altering element is further downsized due to the synergistically combined effects of the downsizing effect provided by the first-type optical element and the downsizing effect provided by the optical axis altering element. That is, the invention provides a variable magnification optical system that is easily downsized (slimmed-down) by use of at least one optical element (first-type optical element).

As described above, according to the invention, by adding the first-type optical element to the variable magnification optical system, a beam is altered so as to be nonaxisymmetric to the optical axis. Accordingly, the lens diameters of the lens groups of the variable magnification optical system can also be downsized in the direction in which the beam is compressed due to its nonaxisymmetric property, resulting in downsizing of the variable magnification optical system and then an image-taking apparatus including this variable magnification optical system.

The object described above and other objects and features of the invention will be clarified with the following description of preferred embodiments and also with reference to the accompanying drawings.

### BRIEF DESCRIPTION OF THE DRAWINGS

FIG. 1 is a schematic block diagram showing the internal construction of a lens unit according to the present invention;

FIG. 2 is a schematic perspective view mainly showing an anamorphic lens element, an optical prism, and an image sensor of FIG. 1;

FIG. 3 is an elevation view showing the front surface of the anamorphic lens element;

FIG. 4 is a side view showing the side surface of the anamorphic lens element as viewed vertically from the front;

FIG. 5 is a plan view showing a beam that is imaged onto the light-receiving surface of the image sensor by being directed by lens groups and the optical prism;

FIG. 6 is a plan view showing a beam that is imaged onto the light-receiving surface of the image sensor by being directed by the anamorphic lens element, the lens groups and the optical prism;

FIG. 7 is a schematic block diagram showing another example of the internal construction of the lens unit of FIG. 1;

FIG. 8 is a schematic perspective view mainly showing another example of the anamorphic lens element, the optical prism, and the image sensor of FIG. 2;

FIG. 9 is a perspective view showing the exterior of a digital camera according to the invention;

FIG. 10 is an elevation view showing the front side of the digital still camera;

FIG. 11 is a rear view showing the rear surface of the digital still camera;

FIG. 12 is a side view showing the side surface of the digital still camera;

FIG. 13 is a schematic block diagram showing the internal construction of the digital still camera.

### DETAILED DESCRIPTION OF PREFERRED EMBODIMENTS

### First Embodiment

The first embodiment of the present invention will be described below with reference to the accompanying drawings. For arrows provided to indicate directions in the figures, a mark “●” indicates the direction vertical to the paper surface.

<1. Construction of a Digital Still Camera>

<1.1 Exterior of the Digital Still Camera>

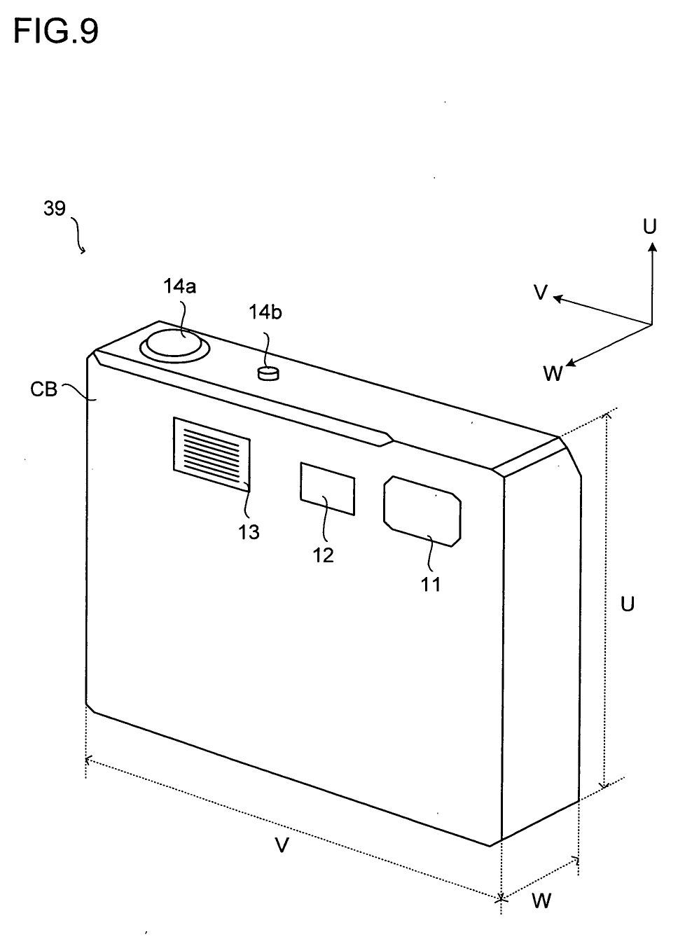

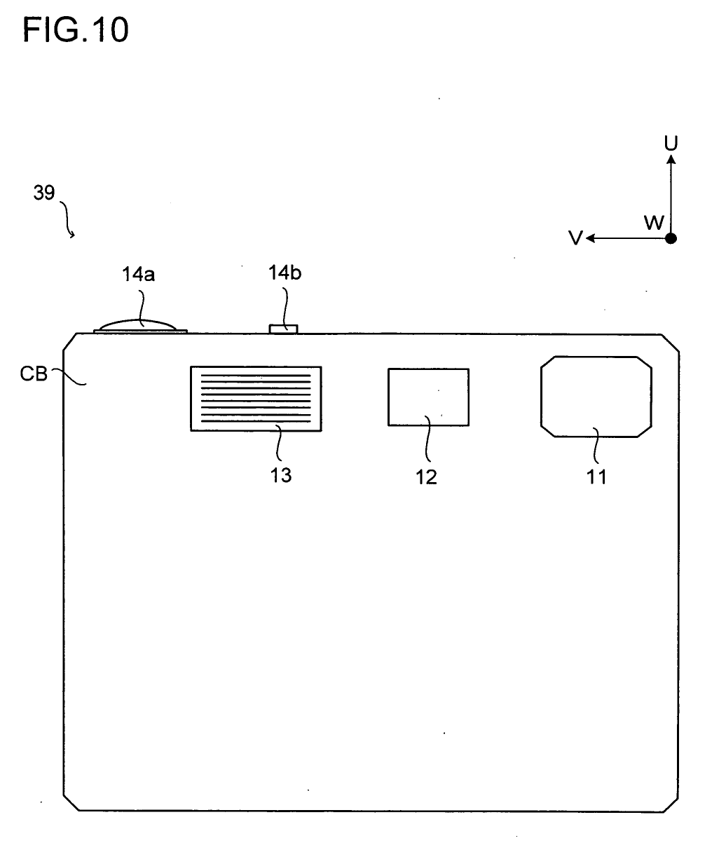

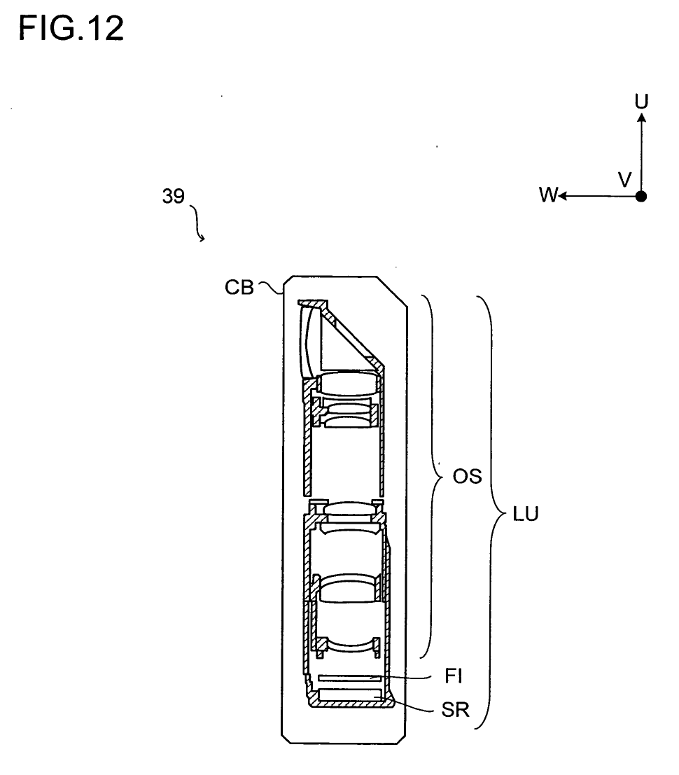

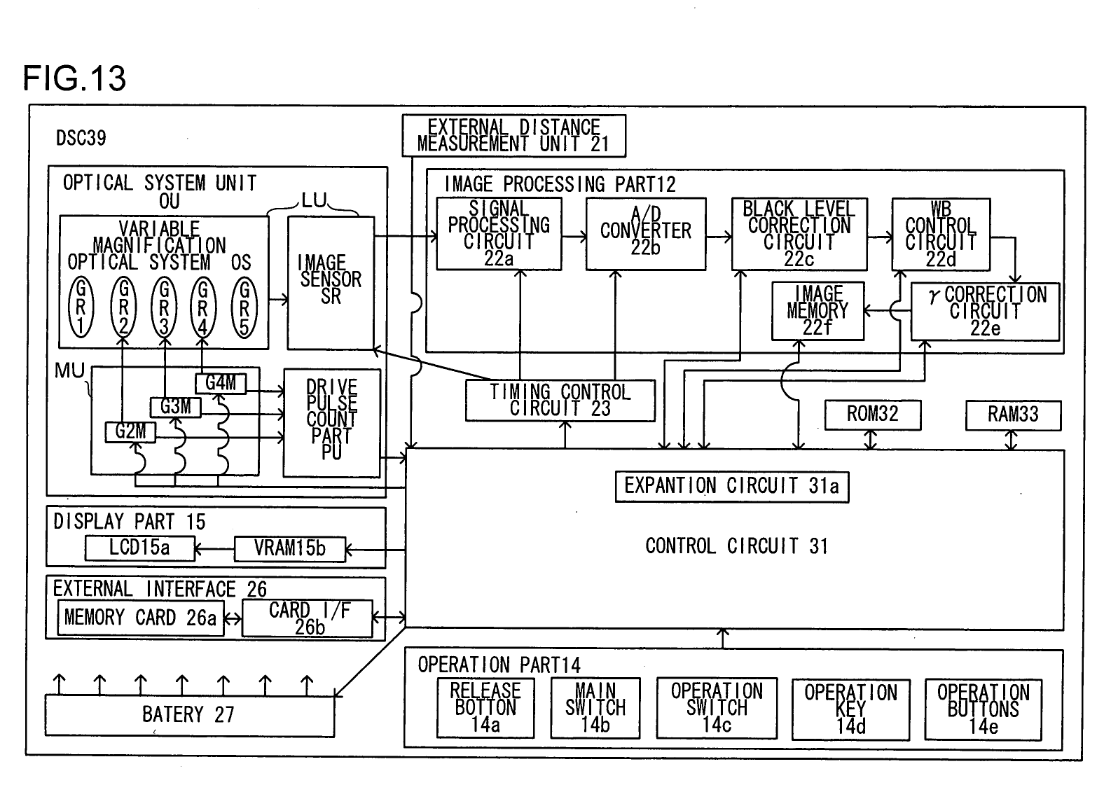

FIG. 9 shows the digital still camera (DSC) 39 as an example of an image-taking apparatus of the invention. FIGS. 10 to 12 show the front, rear, and side surfaces of the DSC 39, respectively, (together with a lens unit LU therein schematically shown as viewed from the side in FIG. 12). FIG. 13 shows the internal construction of the DSC 39. Note that U denotes the height direction of the DSC 39, V denotes the horizontal direction thereof, and W denotes the depth (width) direction thereof.

As shown in FIGS. 9 and 10, on the front surface of a camera body (main body portion) CB of the DSC 39 are provided at least: an opening 11 which permits the front surface of the lens unit LU (the lens element located on the most object side in the lens unit LU) to be exposed; an optical finder 12; and a flash emitting part 13.

On the top surface of the camera body CB, a release button 14a and a main switch 14b are provided. The release button 14a is operated to give directions for recording a photographed image. The main switch 14b is operated to give directions for starting and stopping the entire operation of the DSC 39, i.e., for starting and stopping power supply from a power source.

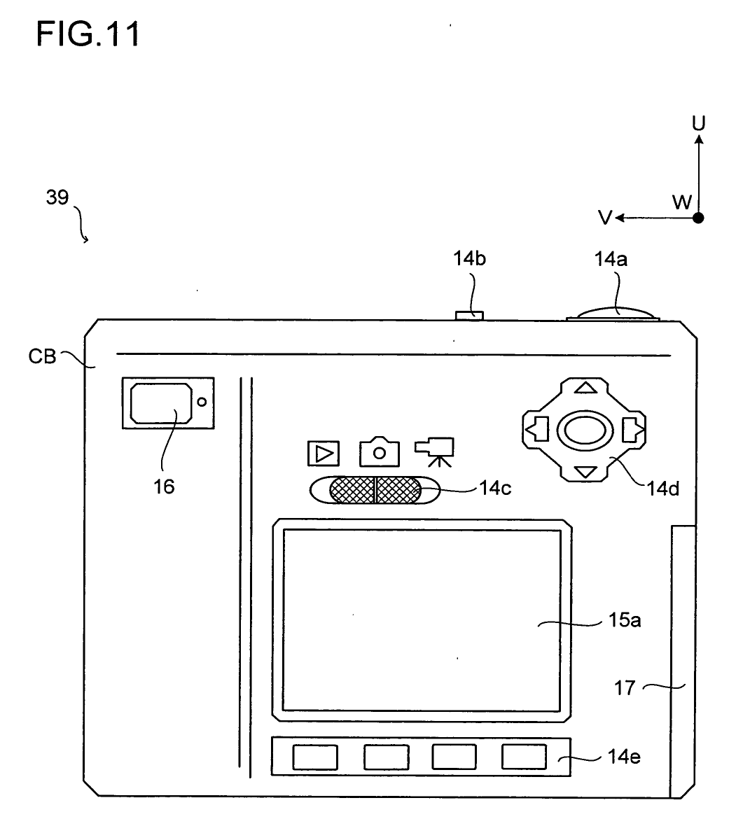

On the rear surface of the camera body CB, as shown in FIG. 11, are provided: a slide-type operation switch 14c; an LCD 15a; an operation key 14d having four contacts; a plurality of operation buttons 14e, an eyepiece window 16 of the optical finder 12; and a cover 17.

The DSC 39 of the invention has three operation modes: a camera mode in which a still image is photographed; a moving image mode in which a moving image is photographed, and a reproduction mode in which an image recoded on a memory card is reproduced and displayed. The operation switch 14c is operated to switch among these modes. Near the operation switch 14c, three marks are provided which indicate these operation modes.

The LCD 15a displays the setting condition and operation guides of the DSC 39, and also displays photographed images and recorded images. In addition, the LCD 15a immediately displays a photographed image to provide a live view, thereby functioning as an electronic view finder.

The operation key 14d is operated to change the zooming, i.e., photographing magnification, in the camera mode and the moving image mode. In the reproduction mode, the operation key 14d is operated to select an image to be reproduced. In addition, when the LCD15a displays the guide for photographing condition settings, the operation key 14d is operated to select a parameter from among those included in this display.

The operation buttons 14e are operated to switch between display of the operation guide and non-display of the operation guide, and also to set the selected parameter.

The cover 17 is so provided as to extend from the rear surface to the side surface of the camera body CB. With this cover 17 open, there are found inside the camera body CB a slot for fitting a detachable memory card where a photographed image is recorded and a slot for fitting a rechargeable battery as the power source of the DSC 39. The cover 17 covers the fitted memory card and battery.

<1-2. The Internal Construction of the Digital Still Camera>

Now, the internal construction of the DSC 39 will be described with reference to FIG. 13. As shown in FIG. 13, the DSC 39 includes: an optical system unit OU, an external distance measurement unit 21, an image processing part 22, a timing control circuit 23, an operation part 14, a display part 15, an external interface part 26, a battery 27, a control part 31, a ROM 32, and a RAM 33.

<Optical System Unit>

The optical system unit OU includes: a lens unit LU composed of a variable magnification optical system OS having a plurality of lens groups (GR1 to GR5) and an image sensor SR; a lens group moving part MU; and a drive pulse count part PU. Note that each of the figures provided to the lens groups indicates the position in order of arrangement from the object side to the image side.

The variable magnification optical system OS is an optical system included in the lens unit LU, and takes in a ray from a subject (photographing object). This variable magnification optical system OS performs zooming, focusing, and the like by changing gaps between the lens groups (GR1 to GR5) along the optical axis.

The image sensor SR receives a ray (optical image) taken in by the variable magnification optical system OS, and converts it into an electrical signal (electronic data). Examples of the image sensor SR include a CCD (Charge Coupled Device) area sensor, a CMOS (Complementary Metal Oxide Semiconductor) sensor, and the like. The image sensor SR has a large number of pixels provided in three types that selectively receive light of red (R), green (G), and blue (B) colors, respectively.

The lens group moving part (drive source) MU moves the lens groups GRs in the variable magnification optical system OS. One example of the lens group moving part MU is stepping motors (G2M to G4M, drive source) that are provided in correspondence with the lens groups to be moved (for example, GR2 to GR4).

The drive pulse count part PU counts drive pulses of the stepping motors (G2M to G4M) to thereby calculate the moving distances of moving lens groups (for example, GR2 to GR4) and thus obtain the position of each lens group.

<External Distance Measurement Unit>

The external distance measurement unit 21 receives, for example, a ray (reflecting ray) from a subject and performs passive measurement of the distance from the subject.

<The Image Processing Part>

The image processing part 22 forms image data based on electronic data generated by the image sensor SR. More specifically, this image processing part 22 includes a signal processing circuit 22a, an A/D converter 22b, a black level correction circuit 22c, a white balance control circuit (WB control circuit) 22d, a γ correction circuit 22e, and an image memory 22f.

The signal processing circuit 22a processes analog signals outputted from the pixels included in the image sensor SR. The A/D converter 22b converts a processed analog signal from the signal processing circuit 22a into a digital signal.

The black level correction circuit 22c corrects the level of an entire digital signal. The WB control circuit 22d controls the white balance of an image by adjusting levels of signals of three colors R, G, and B that are outputted from the three types of pixels included in the image sensor SR.

The γ correction circuit 22e performs non-linearization processing on a digital signal so that the signal is suitably displayed. The image memory 22f temporarily stores image data that has been formed through the signal processing circuit 22a, the A/D converter 22b, the black level correction circuit 22c, the white balance control circuit (WB control circuit) 22d, and the γ correction circuit 22e.

<Timing Control Circuit>

The timing control circuit 23 forms drive control signals for the image sensor SR, the signal processing circuit 22a, and the A/D converter 22b based on reference clocks transmitted from the control part 31.

<Operation Part>

The operation part 14 includes buttons, switches, and the like for giving directions to the control part 31 concerning the contents of various operations made by the user. In the DSC 39 of the invention, at least the release button 14a, the main switch 14b, the operation switch 14c, the operation key 14d, and the operation buttons 14e as described above are included.

<Display Part>

The display part 15 includes a VRAM 15b and the LCD 15a. The VRAM 15b stores image data to be displayed on the LCD 15a. The LCD 15a displays various data, such as image data, that are stored in the VRAM 15b.

<External Interface>

The external interface part 26 includes a memory card 26a and a card interface (card I/F) 26b that permits inputting and outputting performed by the memory card 26a.

<Battery and Control Part>

The battery 27 supplies power to the various members described above. The control part 31 is a brain that performs control of the operation of the entire DSC 39, and the like, and thus organically controls the driving of each member included in the DSC 39 for integrated operation control. For example, in the DSC 39 of the invention, the control part 31 performs a control for permitting both moving image photographing and still image photographing, a control of the operation of the stepping motors (G2M to G4M), and the like. For the control part 31, a description will be given later.

<ROM and RAM>

The ROM (Read Only Memory) 32 or the RAM (Random Access Memory) 33 store control programs required for the operation control of each member performed by the control part 31, required data tables, and the like.

<1-3. Construction of the Lens Unit>

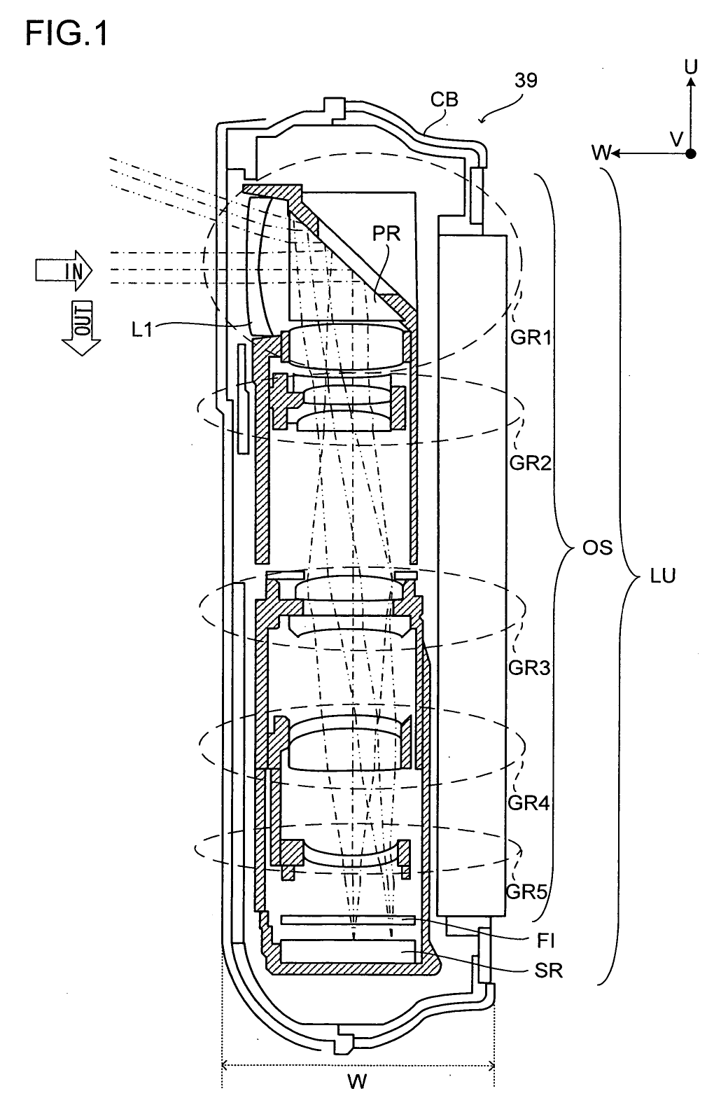

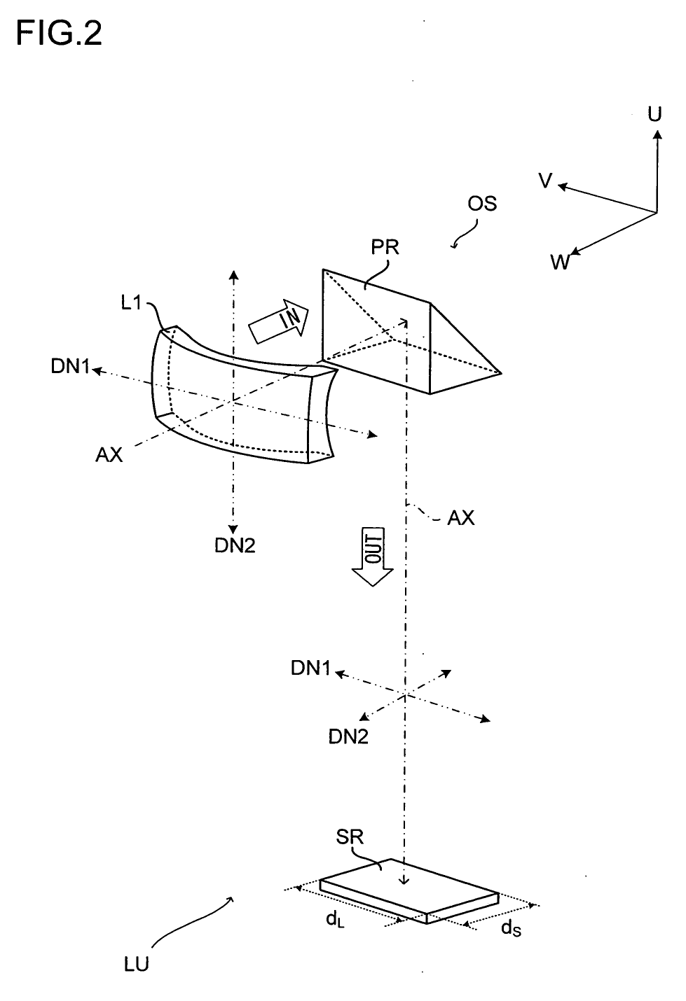

Now, the lens unit LU will be described in detail below, with reference to FIGS. 1 and 2. FIG. 1 is a detailed view of FIG. 12, showing the interior of the lens unit LU. FIG. 2 is a view mainly showing an anamorphic lens element L1 (to be described later), an optical prism PR, and the image sensor SR in the lens unit LU.

As shown in FIG. 1, the lens unit LU includes the variable magnification optical system OS and the image sensor SR. The variable magnification optical system OS includes a plurality of lens elements and an optical prism PR. The plurality of lens elements and the optical prism PR are divided to several groups (lens groups).

For example, the variable magnification optical system OS in FIG. 1 includes five lens groups (GR1 to GR5) located from the object side and to the image side (image sensor SR). The optical prism PR is included in the first lens group GR1 that is located closest to the object side. Note that an optical axis direction AX of a ray incident on the optical prism PR is referred to as an incidence direction IN while an optical axis direction AX of a ray deflected by the optical prism PR is referred to as an emergence direction OUT. The optical prism PR deflects the optical axis AX so that the angle formed by the incidence diction IN and the emergence direction OUT becomes substantially 90 degrees.

The image sensor SR is a photoelectric transducer, such as a CCD, as described above, and formed in, for example, a rectangular shape. The lengths of the sides of the image sensor SR are referred to as d_{S} (for short side) and d_{L} (for long side).

The image sensor SR such as a CCD has sensitivity to the wavelength region (long wavelength region) of infrared rays. This infrared ray (IR) may have an adverse effect on the light-receiving surface (image-taking surface) of the image sensor SR. To avoid such an adverse effect, an IR cut filter FI may be arranged which removes (absorbs) infrared rays from rays incident on the image sensor SR.

<Anamorphic Lens>

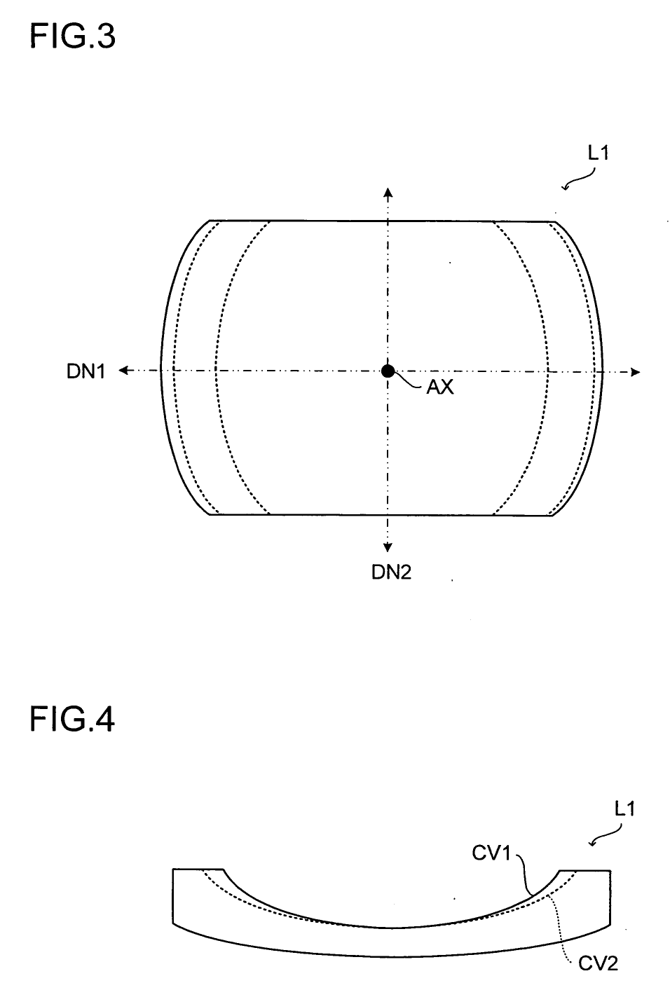

Now, the lens element included in the lens unit LU, more specifically, the anamorphic lens element L1 included on the most object side in the first lens group GR1 will be described in detail below. The anamorphic lens element L1 is formed as shown in FIGS. 3 (elevation view) and 4 (side composite chart).

The anamorphic lens element L1 is a lens element that has refractive powers (with a power defined by the reciprocal of a focal length) respectively corresponding to a plurality of different directions orthogonal to the optical axis AX. Thus, the anamorphic lens element L1 has a surface including different kinds of curvatures. For example, as shown in FIGS. 2 and 3, assume that two mutually orthogonal directions both orthogonal to the optical axis AX are a first direction (horizontal direction) DN1 and a second direction (vertical direction) DN2. Then, as shown in FIG. 4, the surface having the curvature corresponding to the first direction DN 1 is indicated as CV1 and the surface having the curvature corresponding to the second direction DN2 is indicated as CV2.

Thus, providing the lens surface with two kinds of curvatures generates refractive powers respectively corresponding to these curvatures. Therefore, of rays transmitted through the anamorphic lens element L1, the focal lengths of the rays corresponding to the mutually orthogonal directions (DN1 and DN2) are different from each other. Then a beam shined on the light-receiving surface of the image sensor SR exhibits different shapes depending on whether or not the anamorphic lens element L1 is provided.

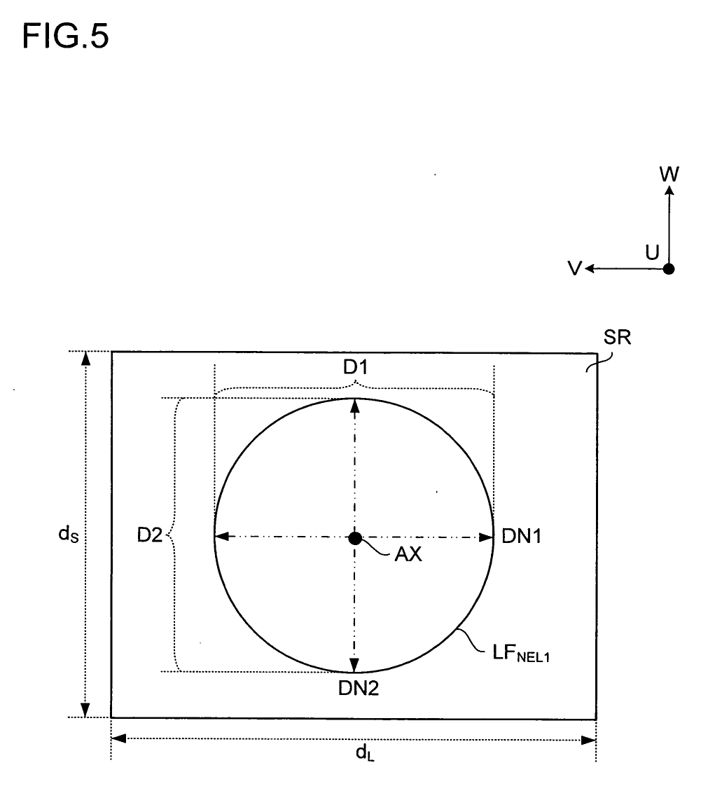

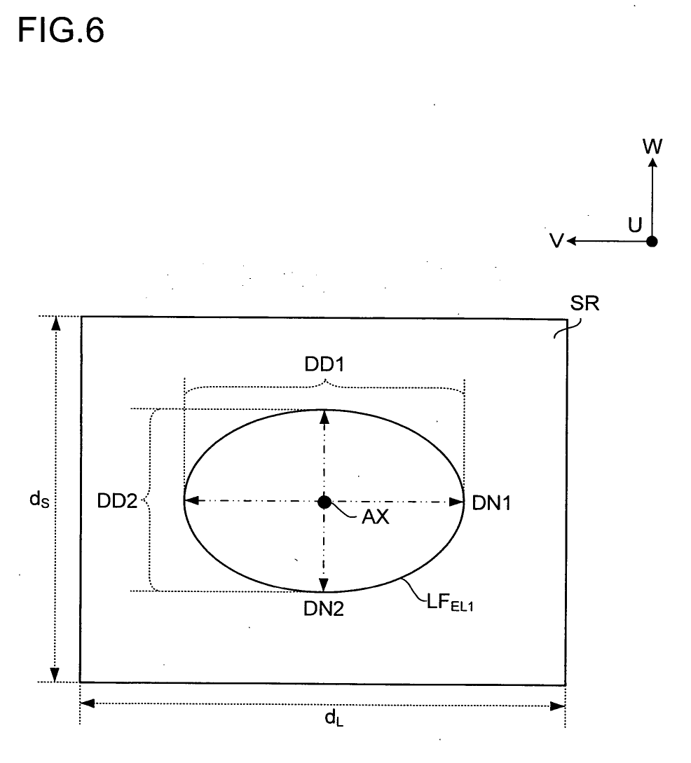

Now, a description will be given on the shape of an arbitrary beam on the light-receiving surface of the image sensor SR, with reference to FIGS. 5 and 6. A case where no anamorphic lens element L1 is provided refers to, for example, the case of the variable magnification optical system OS where all the lens surfaces provided have the same curvature corresponding to the first direction DN1 and the second direction DN2 and where a beam LF_{NEL1} axisymmetric to the optical axis AX can be imaged on the light-receiving surface of the image sensor SR.

FIG. 5 shows a beam LF_{NEL1} on the light-receiving surface of the image sensor SR when the anamorphic lens element L1 is not provided. On the other hand, FIG. 6 shows a beam LF_{EL1} on the light-receiving surface of the image sensor SR when the anamorphic lens element L1 is provided. Assume that, in FIG. 5, the width (width dimension) of the beam corresponding to the first direction DN1 is D1 and that the wide of the beam corresponding to the second direction DN2 is D2. Assume that, in FIG. 6, the width of the beam corresponding to the first direction DN1 is DD1 and that the wide of the beam corresponding to the second direction DN2 is DD2.

As shown in FIGS. 5 and 6, when the anamorphic lens element L1 is provided, the beam LF_{EL1} is compressed in the second direction DN2 (compression direction) compared to when the anamorphic lens element L1 is not provided. That is, the beam LF_{NEL1} is altered by the anamorphic lens element L1 so as to be nonaxisymmetric to the optical axis AX.

This phenomena is attributable to the refractive power corresponding to the second direction being larger than the refractive power corresponding to the first direction on the lens surfaces of the anamorphic lens element L1. Therefore, the anamorphic lens element L1 is a lens that performs magnification change (compression) by compressing, in the second direction DN2, a beam LF_{NEL1} formed with the width dimensions D1 and D2 into a beam LF_{EL1} formed with the width dimensions DD1 and DD2.

Coefficients (K1 and K2) for the magnification change of the beam LF_{NEL1} from the width dimensions (D1 and D2) to the width dimensions (DD1 and DD2) can be expressed:
K1=DD1/D1
K2=(DD2/D2)/K1.
<Direction in Which a Beam is Compressed by the Anamorphic Kens Element>

The utilization of the beam compression capability of the anamorphic lens element L1 can reduce the thickness of the variable magnification optical system OS, because a lens element capable of condensing a beam that has been relatively downsized through compression is downsized in correspondence with the beam size.

Therefore, it is desirable that a desired direction in which the variable magnification optical system OS (and then the lens unit LU) is downsized agree with the direction of compression performed by the anamorphic lens element L1.

In a variable magnification optical system (bending optical system) OS employing an optical prism PR, such as is provided by the present invention, downsizing is typically achieved by deflecting (right-angle deflection, or the like) the optical axis AX in the incidence direction IN with respect to the optical prism PR. That is, the bending optical system OS is shortened in the direction which is supposed to extend along the incidence direction IN in the case of a straight optical system (i.e., in the incidence direction IN).

Thus, in the variable magnification optical system OS of the invention, it is preferable that the incidence direction IN and the second direction DN2, i.e. the direction of compression performed by the anamorphic lens element L1 agree with each other. More specifically, the second direction DN2 with respect to the optical axis direction AX (i.e., emergence direction OUT) after deflection by the optical prism PR agree with the incidence direction IN.

<1-4. One Example of Functions Performed by the Control Part>

When a beam LF_{EL1} altered by the anamorphic lens element L1 so as to be nonaxisymmetric to the optical axis is imaged on the light-receiving surface, image data based on this nonaxisymmetric beam LF_{EL1} (nonaxisymmetric image data) is not directly casted as a display image on the LCD 15a or the like. That is, image data formed by the image sensor SR based on a beam LF_{EL1} is processed by the control part 31 to be thereby converted into image data based on an axisymmetric beam (axisymmetric image data).

This conversion processing is, more specifically, expansion processing which employs a predetermined expansion coefficient. The expansion coefficient is obtained from the magnification (compression rate) of a ray corresponding to a desired direction for expansion. For example, in the case of the beam LF_{EL1} as shown in FIG. 6, the expansion coefficient is obtained from the magnification of the ray corresponding to the second direction DN2. Then, with the obtained expansion coefficient, image data based on the ray corresponding to the second direction DN2 is subjected to expansion processing.

Through such conversion processing performed by the control part 31 (more specifically, an expansion circuit 31a included in the control part 31), an image to be displayed on the LCD 15a or the like results in a display image equivalent to a display image of image data based on a beam axisymmetric to the optical axis AX. Thus, the DSC 39 of the invention never displays on the LCD 15a an image that gives a sense of discomfort to the user. Moreover, with such a DSC 39, another optical element is not required for restoring a nonaxisymmetric beam LF_{EL1} to an axisymmetric beam LF_{EL1}, thus permitting effective use of limited space in the lens unit LU and the DSC 39.

<2. One Example of Various Features Provided by the Invention>

As described above, the variable magnification optical system OS mounted in the lens unit LU includes: the plurality of lens groups (GR1 to GR5) that image a ray from the object side on the light-receiving surface of the image sensor SR; and the optical prism PR that deflects the optical path of a ray guided by these plurality of lens groups (GR1 to GR5). Moreover, the variable magnification optical system OS includes the anamorphic lens element L1, which alters a beam of rays so that the beam becomes nonaxisymmetric to the optical axis AX.

Such a change (phenomena) is attributable to the property of the anamorphic lens element L1 having refractive powers respectively corresponding to a plurality of different directions orthogonal to the optical axis AX. For example, in a case where the beam LF_{EL1} as shown in FIG. 6 is formed, this change occurs due to the fact that the anamorphic lens element L1 has the refractive power corresponding to the second direction DN2 thereof which is larger than the refractive power corresponding to the first direction DN1 thereof.

Thus, when the width (for example, width dimension DD2) of a beam corresponding to one direction (the second direction DN2) orthogonal to the optical axis AX is relatively short, the lens diameters of the lens elements and the lens groups (GR2 to GR5) located closer to the image side than the anamorphic lens element L1 can be shortened in one direction in correspondence with the width dimension of the beam shortened in aforementioned one direction, because these lens elements and lens groups are only required to have a diameter (size) sufficient enough to condense a beam having a relatively shortened width dimension (for example, width dimension DD2).

Accordingly, the variable magnification optical system OS (then the lens unit LU) provided with the anamorphic lens element L1 can have relatively downsized lens groups (then lens elements) arranged closer to the image side than the anamorphic lens element L1, which results in downsizing of the variable magnification optical system OS itself (due to the downsizing effect provided by the anamorphic lens element L1). Consequently, the DSC 39 provided with such a variable magnification optical system OS can be relatively downsized.

In the variable magnification optical system OS of the invention, the optical prism PR deflects the optical axis AX so that the angle formed by the incidence direction IN and the emergence direction OUT becomes substantially 90 degrees. The anamorphic lens element L1 and the optical prism PR are arranged so that the second direction DN2 with respect to the emergence direction OUT and the incidence direction IN are oriented in the same direction.

As described above, the downsizing of the variable magnification optical system OS (bending optical system) employing the optical prism PR is achieved by deflecting (right-angle deflection or the like) the optical axis AX in the incidence direction IN with respect to the optical prism PR (due to the downsizing effect provided by the optical prism PR).

Then, when this incidence direction IN agrees with the direction in which a beam is compressed by the anamorphic lens element L1 (second direction DN2), the downsizing effect provided by the optical prism PR and the downsizing effect (downsizing of the lens diameter along the compression direction) provided by the anamorphic lens element L1 are combined synergistically.

The use of the lens unit LU including such a variable magnification optical system OS in particular can achieve effective downsizing of the DSC 39, for example, when a desired direction in which the DSC 39 is slimmed down (for example, the depth direction W) and the direction in which the variable magnification optical system OS is slimmed down (incidence direction IN) agree with each other.

To achieve this, in the DSC 39, the optical prism PR is arranged so that the incidence direction IN agrees with the direction in which the DSC 39 is slimmed down most. In addition, the anamorphic lens element L1 is arranged so that the second direction DN2 with respect to the emergence direction OUT agrees with the incidence direction IN.

With the DSC 39 described above, the direction in which the variable magnification optical system OS (the second direction DN2) is relatively downsized agrees with the depth direction W of the DSC 39. Therefore, a beam, a critical factor determining the thickness of the DSC 39, is compressed by the use of the anamorphic lens element L1, thereby achieving further downsizing of the DSC 39 of the invention.

However, excessive compression of a beam causes various aberrations, for example, curvature of field. Therefore, it is desirable that a beam be compressed within the range that permits the downsizing of the lens unit LU (and then the DSC 39) while suppressing the occurrence of various aberrations.

For this range, the magnification coefficient K1 for the width dimension of a beam corresponding to the first direction can be an arbitrary value, and the magnification coefficient K2 for the width dimension of the beam corresponding to the second direction can be any value as long as it satisfies the following:
0.60≦K2≦0.95

### Second Embodiment

The second embodiment of the invention will be described below. Members having the same functions as those employed in the first embodiment are provided with the same numerals and thus are omitted from the description.

In the DSC 39 of the first embodiment, the control part 31 performs expansion processing on nonaxisymmetric image data to thereby convert it into axisymmetric image data. However, the present invention is not limited to this. That is, the DSC 39 of the invention is also capable of generating image data to be displayed on the LCD 15a or the like without performing expansion processing.

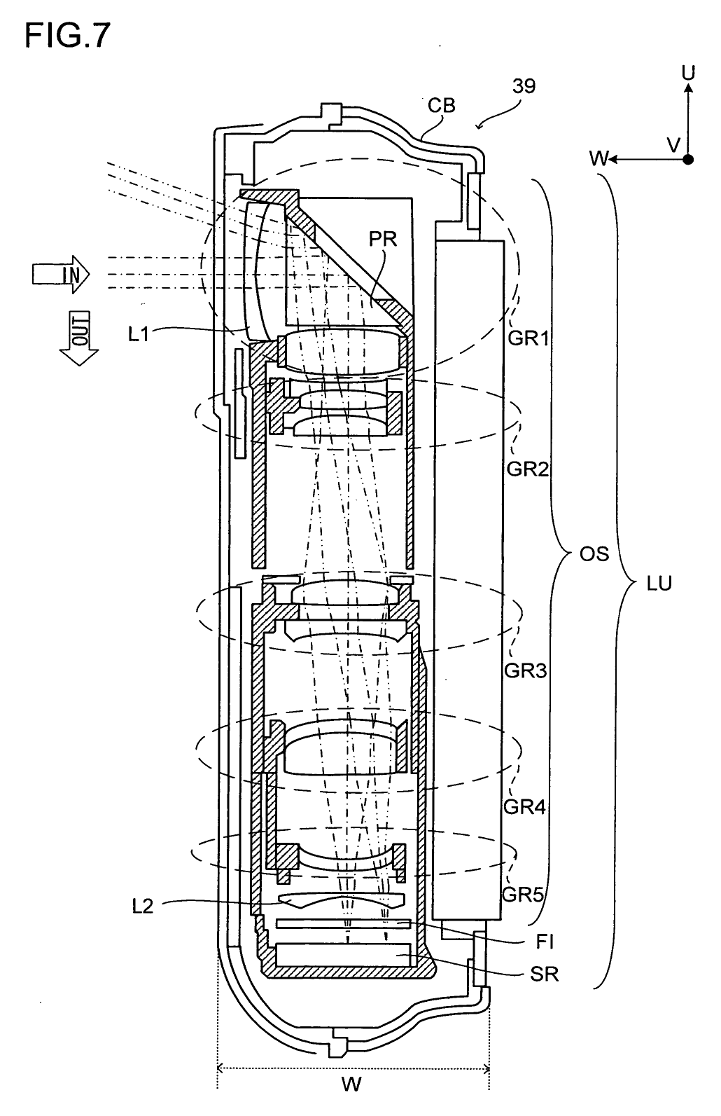

For example, as shown in FIG. 7, it is favorable that a second anamorphic lens element (second-type optical element) L2 be arranged closer to the image side than the anamorphic lens element (a first anamorphic lens element) L1 and the prism PR and also closer to the object side than the image sensor SR. This second anamorphic lens element L2 may be configured to alter a beam, which has been altered by the anamorphic lens element L1 so as to be nonaxisymmetric, into a beam axisymmetric to the optical axis AX.

Thus, as is the case with the anamorphic lens element L1, the second anamorphic lens element L2 has refractive powers respectively corresponding to a plurality of different directions orthogonal to the optical axis AX. However, note that an opposite power relationship exists between the second anamorphic lens element L2 and the first anamorphic lens element L1.

For example, if, of the two directions on the lens surface of the first anamorphic lens element L1, the direction to which a large refractive power corresponds is the second direction DN2 while the direction to which a small refractive power corresponds is the first direction DN1; of the two directions of the lens surface of the second anamorphic lens element L2, a refractive power corresponding to the second direction DN2 is small while a refractive power corresponding to the first direction DN1 is large.

Thus, if the power relationship is opposite between the first anamorphic lens element L1 and the second anamorphic lens element L2, the width dimension in the direction of compression performed by the anamorphic lens element L1 can be expanded, whereby an axisymmetric beam can be imaged on the light-receiving surface of the image sensor SR.

Accordingly, the DSC 39 of the second embodiment can reduce control load (more specifically, control load involved with the expansion processing) imposed on the control part 31 more than the DSC 39 of the first embodiment can.

The arrangement of the anamorphic lens element L2 is not limited. The anamorphic lens element L2 can be arranged at any location that permits a beam, which has been altered by the anamorphic lens element L1 so as to be nonaxisymmetric, to be altered into an axisymmetric beam before reaching the image sensor SR.

The anamorphic lens element L1 is so provided as to compress the diameters of the lens groups (more specifically, lens elements) in the variable magnification optical system OS. That is, the anamorphic lens element L1 is so provided as to downsize a lens group that otherwise tends to have a largest diameter in the variable magnification optical system OS. Therefore, locating the anamorphic lens element L2 at such a position that a beam reaches before reaching the lens group having the largest diameter (lens diameter) makes it difficult to achieve downsizing of the lens groups.

The arrangement of the first anamorphic lens element L1 and the second anamorphic lens element L2 closer to the object side than the optical prism PR cannot achieve the synergically combined effects of the downsizing effect provided by the anamorphic lens element L1 and the downsizing effect provided by the optical prism PR. Thus, it is desirable that, in the variable magnification optical system OS of the invention, the second anamorphic lens element L2 be located closer to the image side than the lens group, of the lens groups located closer to the image side than the optical prism PR, which has the largest diameter.

### Other Embodiments

The present invention is not limited to the embodiments described above. Any modifications to the invention can be made within the scope of the invention.

For example, the anamorphic lens element L1 is a generic term of lens elements that provide different focal lengths of a ray respectively corresponding to a plurality of different directions orthogonal to the optical axis AX. Therefore, such a difference in the focal length can be provided by many types of lens elements, for example, a cylindrical lens element, a toroidal lens element, a free curved surface lens element, and the like. A mirror or a prism, for example, a curved reflective mirror or a curved reflective prism, can also be used which provides different focal lengths respectively corresponding to a plurality of different directions orthogonal to the optical axis AX.

The anamorphic lens element L1 may be arranged closer to the object side than the optical prism PR or may be fitted to the optical prism PR. Alternatively, a single optical element composed of the optical prism and the anamorphic lens element integrally formed together may be used, because any such structure permits a beam to be so altered as to be nonaxisymmetric before the beam reaches the light-receiving surface of the image sensor SR.

It is preferable that the anamorphic lens element L1 be immovable (i.e., fixed) during zooming (magnification variation) and the like. Such structure can suppress the occurrence of various aberrations attributable to the movement of the anamorphic lens element L1. In addition, this fixation can suppress occurrence of condition that the anamorphic lens element L1 is displaced from the predetermined position or tilted.

In the DSC 39 shown in FIG. 2, the variable magnification optical system OS (then the lens unit LU) is arranged so that the height direction of the DSC 39 and the optical axis direction AX (emergence direction OUT) of a ray after passing through the optical prism PR agree with each other (i.e., placed vertically). Then, the direction equal to the horizontal direction V of the DSC 39 is defined as the first direction (horizontal direction) DN1, and the direction equal to the height direction U thereof is defined as the second direction (vertical direction) DN2. The arrangement of the variable magnification optical system OS is, however, not limited to this arrangement.

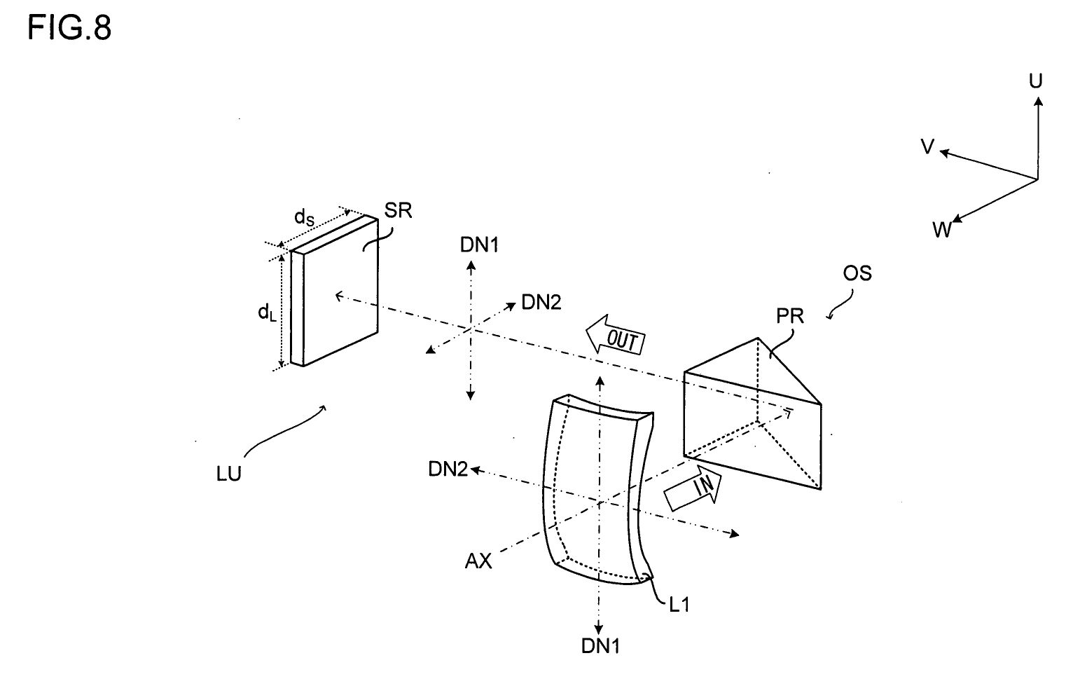

For example, as shown in FIG. 8, the variable magnification optical system OS may be arranged so that the horizontal direction V of the DSC 39 and the optical axis direction AX of a ray after passing through the optical prism PR (emergence direction OUT) agree with each other (i.e., placed horizontally). With such an arrangement, the direction equal to the height direction U of the DSC 39 may be defined as the first direction (vertical direction) DN1 and the direction equal to the horizontal direction V thereof may be defined as the second direction (horizontal direction) DN2. Even with such an arrangement of the variable magnification optical system OS, the features described above and their corresponding effects can be obviously provided.

In the lens unit LU shown in FIGS. 2 and 8, the first direction DN1 and the second direction DN2 with respect to the optical axis of a ray bent by the optical prism PR are oriented in the same directions as a long side direction dL and a short side direction dS, respectively, of the image sensor SR. Therefore, in this case, the first direction DN 1 may be referred to as a long side direction and the second direction DN 2 may be referred to as a short side direction.

The present invention as described above can also be expressed as follows.

For example, to effectively achieve synergistically combined effects of the downsizing effect provided by a first-type optical element and the downsizing effect provided by an optical axis altering element, there are preferable arrangements. One example of such arrangements is that the direction in which a beam is compressed in the emergence direction of the optical axis altering element (for example, the second direction orthogonal to the emergence direction) is oriented in the same direction as the direction of incidence onto the optical axis altering element. That is, the first-type optical element is arranged so that the second direction with respect to the emergence direction agrees with the direction of incidence of a beam onto the optical axis altering element.

Maintaining such an arrangement results in that the direction in which a beam is shortened by the optical altering element (incidence direction) and the direction in which the beam is shortened by the first-type optical element (compression direction, i.e., second direction) agree with each other. Thus, the variable magnification optical system can effectively achieve the synergistically combined effects of the downsizing effect provided by the first-type optical element and the downsizing effect provided by the optical axis altering element.

When a beam is altered by the first-type optical element so as to be nonaxisymmetric (when a beam is compressed), various aberrations may occur. Thus, it is desirable that a beam be compressed within the range that permits the downsizing of the variable magnification optical system while suppressing the occurrence of various aberrations.

An example of such a range will be described below. First, a beam guided by the plurality of lens groups and the optical altering element so as to be imaged on the light-receiving surface of the image sensor is represented by the first width dimension D1 and the second width dimension D2 respectively corresponding to the first direction and the second direction described above. On the other hand, a beam guided by the first-type optical element, the plurality of lens groups, and the optical axis altering element so as to be imaged on the light-receiving surface of the image sensor is represented by the first width dimension DD1 and the second width dimension DD2 respectively corresponding to the first direction and the second direction described above. Then, the first-type optical element forms a beam represented by the first width direction DD1 and the second width direction DD2 that satisfy the following relationship.
DD1=D1×K1
DD2=D2×K1×K2 (0.60≦K2≦0.95)
where
K1 represents the magnification coefficient for the width dimension corresponding to the first direction of a beam on the light-receiving surface of the image sensor; and
K2 represents the magnification coefficient for the width dimension corresponding to the second direction of the beam on the light-receiving surface of the image sensor.

The position of the first-type optical element is not limited to any special position, and thus may be any position as long as it permits the compression of a beam to thereby achieve the downsizing of the variable magnification optical system. Therefore, the first-type optical element may be arranged closer to the object side than the optical axis altering element or may be fitted to the optical axis altering element.

The first-type optical element may be any element, for example, an anamorphic lens element, a cylindrical lens element, a toroidal lens element, a free curved surface lens element, a curved reflective mirror, a curved reflective prism, or the like, which permits altering a beam into a nonaxisymmetric beam.

The variable magnification optical system performs magnification variation (zooming), focusing, and the like by changing gaps between the lens groups along the optical axis. However, it is desirable that the first-type optical element be immovable in the variable magnification optical system during the magnification variation and the like as described above, because such a configuration permits suppressing the occurrence of various aberrations attributable to the movement of the first-type optical element.

It is desirable that a beam incident on the image sensor be not nonaxisymmetric but axisymmetric. Thus, in the variable magnification optical system of the invention, a second optical element is provided for transforming a beam, which has been deformed by the first-type optical element so as to be nonaxisymmetric, back into an axisymmetric beam. For example, this second-type optical element has, as is the case with the first-type optical element, refractive powers respectively corresponding to a plurality of different directions orthogonal to the optical axis of a ray.

The second-type optical element needs to alter the nonaxisymmetric beam formed by the first-type optical element into an axisymmetric beam. Therefore, a power relationship is opposite between the second-type optical element and the first-type optical element. For example, when the first-type optical element has the refractive power corresponding to the second direction thereof which is larger than the refractive power corresponding to the first direction thereof, the second type optical element has the refractive power corresponding to the second direction thereof which is smaller than the refractive power corresponding to the first direction thereof. Such a configuration permits the second-type optical element to expand a beam in the direction in which the beam has been compressed by the first-type optical element (second direction).

The first-type optical element is provided for the purpose of compressing the diameter of the lens groups in the variable magnification optical system. Therefore, locating the second-type optical element at such a position that a ray reaches before reaching the lens group whose lens diameter has been most downsized by compressing the beam (i.e., lens group which has been downsized but has the largest diameter) makes it difficult to downsize the lens groups.

In the variable magnification optical system of the invention, it is desirable that the second-type optical element be arranged closer to the image side than the lens group which has the largest diameter among the lens groups located closer to the image side than the optical axis altering element. With such a configuration, the lens group having the largest diameter can reliably benefit from the downsizing effect provided by the first-type optical element.

Even a nonaxisymmetric beam incident on the image sensor can also be converted into image data representing an axisymmetric beam by processing image data generated by the image sensor.

For example, there is an image-taking apparatus which has a variable magnification optical system including no second-type optical element but a control part for processing, based on a beam incident on the light-receiving surface of an image sensor, image data generated by the image sensor. In this image-taking apparatus, the control part processes image data based on a beam that has been altered by the first-type optical element so as to be nonaxisymmetric, whereby the image data is converted into image data representing an axisymmetric beam.

Examples of this conversion include, for example, expansion processing performed by the control part by use of a predetermined expansion coefficient on image data based on a ray corresponding to the second direction on the light-receiving surface of the image sensor. The expansion coefficient is obtained from the magnification of the ray corresponding to the second direction on the light-receiving surface of the image sensor.

The image-taking apparatus including the variable magnification optical system described above can achieve relatively satisfactory downsizing (slimming-down) following the downsizing of the variable magnification optical system. However, note that the desired direction in which the image-taking apparatus is downsized to a maximum is fixed.

For example, assume that, of a plurality of different directions orthogonal to the optical axis, the mutually orthogonal directions are represented as a first direction and a second direction and that the optical axis direction of a ray incident on the optical axis altering element is represented as an incidence direction while the optical axis direction of a ray deflected by the optical axis altering element is represented as an emergence direction. In the image-taking apparatus, the optical axis altering element is arranged so that the incidence direction agrees with the direction in which the image-taking apparatus is slimmed down most, and the optical axis altering element also deflects the optical axis so that the angle formed by the incidence direction and the emergence direction becomes substantially 90 degrees. Moreover, in this image-taking apparatus, the first-type optical element is arranged so that the second direction with respect to the emergence direction as described above agrees with the incidence direction.

With such a configuration, owing to the presence of the first-type optical element, the desired direction in which the variable magnification optical system is shortened by the optical axis altering element (incidence direction), the direction in which a beam is compressed by the first-type optical element (second direction), and the desired direction in which the image-taking apparatus is shortened (desired direction in which the image-taking apparatus is slimmed most) agree with one another, thus permitting reliable downsizing of such an image-taking apparatus.

The embodiments, examples, and the like described in detail above are just provided to clarify the details of technologies achieved by the present invention. Thus, the interpretation of the present invention should not be narrowly limited to these detailed examples; therefore, various modifications may be added to the invention within the range of the appendixed claims.

What is claimed is:

1. A variable magnification optical system including: a plurality of lens groups for imaging a ray from an object side onto a light-receiving surface of an image sensor; and an optical axis altering element for deflecting an optical axis of the ray guided by the plurality of lens groups, the variable magnification optical system further including:
a first-type optical element, which alters a beam so that the beam becomes nonaxisymmetric to the optical axis.

2. The variable magnification optical system according to claim 1,
whererin the first-type optical element has refractive powers respectively corresponding to a plurality of different directions orthogonal to the optical axis.

3. The variable magnification optical system according to claim 2,
wherein, where, of the plurality of different directions orthogonal to the optical axis, the mutually orthogonal directions are represented as a first direction and a second direction, the first-type optical element has the refractive power corresponding to the second direction thereof which is larger than the refractive power corresponding to the first direction thereof.

4. The variable magnification optical system according to claim 3,
wherein, where an optical axis direction of a ray incident on the optical axis altering element is represented as an incidence direction while an optical axis direction of a ray deflected by the optical axis altering element is an emergence direction, the optical axis altering element deflects the optical axis so that an angle formed by the incidence direction and the emergence direction becomes substantially 90 degrees, and
wherein the first-type optical element is arranged so that the second direction with respect to the emergence direction agrees with the incidence direction.

5. The variable magnification optical system according to claim 3,
wherein, where a beam guided by the plurality of lens groups and the optical axis altering element to be thereby imaged on the light-receiving surface of the image sensor is represented by a first width dimension D1 and a second width dimension D2 respectively corresponding to the first direction and the second direction while a beam guided by the first-type optical element, the plurality of lens groups, and the optical axis altering element to be thereby imaged on the light-receiving surface of the image sensor is represented by a first width dimension DD1 and a second width dimension DD2 respectively corresponding to the first direction and the second direction, the first-type optical element forms a beam represented by the first width dimension DD1 and the second width dimension DD2 that satisfy a relationship below:
DD1=D1×K1
DD2=D2×K1×K2 (0.60≦K2≦0.95)
where
K1 represents a magnification coefficient for a width dimension corresponding to the first direction of a beam on the light-receiving surface of the image sensor; and
K2 represents a magnification coefficient for a width dimension corresponding to the second direction of the beam on the light-receiving surface of the image sensor.

6. The variable magnification optical system according to claim 4,
wherein, where a beam guided by the plurality of lens groups and the optical axis altering element to be thereby imaged on the light-receiving surface of the image sensor is represented by a first width dimension D1 and a second width dimension D2 respectively corresponding to the first direction and the second direction while a beam guided by the first-type optical element, the plurality of lens groups, and the optical axis altering element to be thereby imaged on the light-receiving surface of the image sensor is represented by a first width dimension DD1 and a second width dimension DD2 respectively corresponding to the first direction and the second direction, the first-type optical element forms a beam represented by the first width dimension DD1 and the second width dimension DD2 that satisfy a relationship below:
DD1=D1×K1
DD2=D2×K1×K2 (0.60≦K2≦0.95)
where
K1 represents a magnification coefficient for a width dimension corresponding to the first direction of a beam on the light-receiving surface of the image sensor; and
K2 represents a magnification coefficient for a width dimension corresponding to the second direction of the beam on the light-receiving surface of the image sensor.

7. The variable magnification optical system according to claim 1,
wherein the first-type optical element is arranged closer to the object side than the optical axis altering element or fitted to the optical axis altering element.

8. The variable magnification optical system according to claim 1,
wherein the first-type optical element is an anamorphic lens element, a cylindrical lens element, a toroidal lens element, a free curved surface lens element, a first curved reflective mirror, or a curved reflective prism.

9. The variable magnification optical system according to claim 1,
wherein the first-type optical element is immovable during magnification variation.

10. The variable magnification optical system according to claim 3, including a second-type optical element, which alters a beam, which has been altered by the first-type optical element so as to be nonaxisymmetric, into a beam axisymmetric to the optical axis.

11. The variable magnification optical system according to claim 10,
wherein the second-type optical element is arranged closer to an image side than the lens group, of the lens groups located closer to the image side than the optical axis altering element, which has a largest diameter.

12. An image-taking apparatus comprising a variable magnification optical system including: a plurality of lens groups for imaging a ray from an object side onto a light-receiving surface of an image sensor; and an optical axis altering element for deflecting an optical axis of the ray guided by the plurality of lens groups, the variable magnification optical system further including a first-type optical element, which alters a beam so that the beam becomes nonaxisymmetric to the optical axis.

13. The image-taking apparatus according to claim 12, further including a second-type optical element, which alters the beam, which has been altered by the first-type optical element so as to be nonaxisymmetric, into a beam axisymmetric to the optical axis.

14. The image-taking apparatus according to claim 12, further comprising a control part for processing, based on a beam on the light-receiving surface of the image sensor, image data generated by the image sensor,
wherein the control part processes image data based on the beam, which has been altered by the first-type optical element so as to be nonaxisymmetric, to thereby convert said image data into image data representing an axisymmetric beam.

15. The image-taking apparatus according to claim 14,
wherein, where, of a plurality of different directions orthogonal to the optical axis, the mutually orthogonal directions are represented as a first direction and a second direction, the control part performs expansion processing, by use of a predetermined expansion coefficient, on image data based on a ray corresponding to the second direction on the light-receiving surface of the image sensor, and
wherein the expansion coefficient is obtained from a magnification of the ray corresponding to the second direction on the light-receiving surface of the image sensor.

16. The image-taking apparatus according to claim 12,
wherein, where, of a plurality of different directions orthogonal to the optical axis, the mutually orthogonal directions are represented as a first direction and a second direction while an optical axis direction of a ray incident on the optical axis altering element is an incidence direction and an optical axis direction of a ray deflected by the optical axis altering element is an emergence direction, the optical axis altering element is arranged so that the incidence direction agrees with a desired direction in which the image-taking apparatus is slimmed down most, and also the optical axis altering element deflects the optical axis so that an angle formed by the incidence direction and the emergence direction becomes substantially 90 degrees, and
wherein the first-type optical element is arranged so that the second direction with respect to the emergence direction agrees with the incidence direction.
